(19) United States
(12) Patent Application Publication
(10) Pub. No.: US 2004/0112344 A1
(43) Pub. Date: Jun. 17, 2004

(54) Temperature control for gas assisted fuel delivery

(76) Inventors: Christopher G. Wark, Peoria, IL (US); Cathy Y. Choi, Morton, IL (US)

Correspondence Address: CATERPILLAR INC., 100 N.E. ADAMS STREET, PATENT DEPT., PEORIA, IL, 616296490

(21) Appl. No.: 10/321,157

(22) Filed: Dec. 17, 2002

(51) Int. Cl. F02M 25/07

(52) U.S. Cl. 123/568.15; 123/585

(57) ABSTRACT

A method and apparatus for atomizing fuel being delivered for combustion. The method and apparatus includes providing a stream of pressurized gas, controlling a temperature of the stream of gas to a desired temperature, and injecting a quantity of fuel into the stream of gas, wherein the desired temperature is selected to atomize the fuel to a desired fuel droplet size.

### TECHNICAL FIELD

This invention relates generally to a method and apparatus for atomizing a liquid fuel and, more particularly, to a method and apparatus for controlling a size of atomized fuel droplets by temperature control of a gas for gas assisted fuel delivery.

### BACKGROUND

Atomization of a liquid, e.g., a liquid fuel used for combustion, is often desired. For example, when introducing a liquid fuel into a combustion chamber, the most efficient combustion takes place when the fuel is completely vaporized and preferably when the fuel has completely and thoroughly mixed with ambient gases also present in the chamber. The fuel vaporizes more quickly and readily when the fuel has been atomized to the smallest droplet size possible.

Gas assist injectors have long been used to atomize fuel prior to entry into combustion chambers. For example, in U.S. Pat. No. 4,759,335, Ragg et al. disclose a system which injects fuel directly into a combustion chamber by the use of compressed gas, i.e., compressed air.

More recently, in U.S. Pat. No. 5,241,938, Takagi et al. disclose a fuel injector which includes an air assist passage for atomizing the fuel during injection.

In U.S. Pat. No. 5,746,189, Kuzuya et al. disclose a gas assist system in which exhaust gas recirculation (EGR) gas is used with gas assist injectors. The EGR gas offers the added benefit of keeping combustion temperature down in the combustion chamber.

All of the above listed references and others are effective to atomize fuel to an extent, but may not be sufficient for some applications, such as when a homogeneous mixture of fuel and air is desired.

The present invention is directed to overcoming one or more of the problems as set forth above.

### SUMMARY OF THE INVENTION

In one aspect of the present invention a method for atomizing fuel being delivered for combustion is disclosed. The method includes the steps of providing a stream of pressurized gas, controlling a temperature of the stream of gas to a desired temperature, and injecting a quantity of fuel into the stream of gas, wherein the desired temperature is selected to atomize the fuel to a desired fuel droplet size.

In another aspect of the present invention an apparatus for atomizing fuel being delivered for combustion is disclosed. The apparatus includes a source of gas being delivered in a stream, a compressor located such that the stream of gas passes therethrough and is pressurized, a temperature control unit located such that the stream of gas passes therethrough and is controlled to a desired temperature, a fuel injector for injecting fuel into the stream of gas after the gas passes through the compressor and the temperature control unit, wherein the fuel is atomized to a desired fuel droplet size as a function of the desired temperature, and a combustion chamber for receiving the atomized fuel for combustion.

### BRIEF DESCRIPTION OF THE DRAWINGS

FIG. 1 is a block diagram illustrating a preferred embodiment of the present invention;

FIG. 2 is a block diagram illustrating an alternate embodiment of the present invention;

FIG. 3 is a block diagram illustrating yet another alternate embodiment of the present invention; and

FIG. 4 is a flow diagram illustrating a preferred method of the present invention.

### DETAILED DESCRIPTION

Referring to the drawings, a method and apparatus 100 for atomizing fuel being delivered for combustion is disclosed.

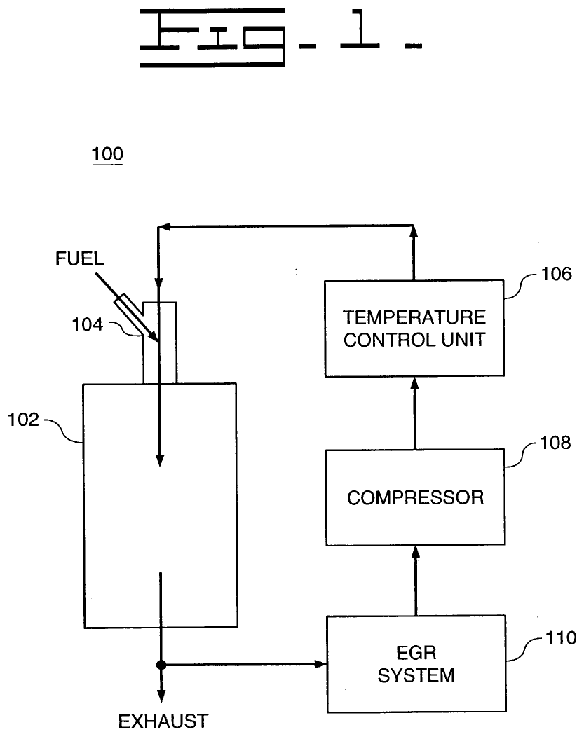

Referring to FIG. 1 in particular, a block diagram illustrating a preferred embodiment is shown. A combustion chamber 102 receives fuel and air, combusts the fuel/air mixture, and exhausts the gases from combustion. The combustion chamber 102 may be part of an internal combustion engine (not shown), as is well known in the art.

A portion of the exhaust gas may be routed through an exhaust gas recirculation (EGR) system 110. EGR systems are well known in the art and need not be described further.

The EGR gas may be sent through a fuel injector 104, in particular, a gas assist fuel injector 104. Gas assist fuel injectors are configured to pass a stream of high pressure gas therethrough. Fuel, in particular liquid fuel such as diesel, gasoline, and the like, is received by the fuel injector 104, which causes the fuel to enter the stream of gas. The gas assisted fuel then atomizes prior to entry into the combustion chamber. It is noted that the fuel injector 104 may be configured for injection into an intake port (not shown) or directly into the combustion chamber 102.

The EGR gas may pass through a compressor 108 prior to entering the fuel injector 104. Gas assist injectors typically require the gas to enter under pressure high enough to overcome the pressure in the combustion chamber 102. Although the EGR gas may have enough pressure initially, it may be required under some engine operating conditions to compress the gas still further.

In the preferred embodiment, the EGR gas passes through a temperature control unit 106 prior to entering the fuel injector 104. An elevated temperature of the gas is desired for the present invention. Preferably, the temperature of the gas as it enters the fuel injector 104 is within a range from about 100 degrees Celsius to about 500 degrees Celsius. More particularly, it is preferred that the temperature of the gas is within a range from about 300 degrees Celsius to about 500 degrees Celsius. Typical temperatures of gases for gas assist injectors, as used in the cited art references, range from about 30 degrees Celsius to about 50 degrees Celsius.

The temperature control unit 106 may increase the temperature of the gas to a desired value. However, the temperature control unit 106 may also decrease the temperature of the gas, for example when EGR gas is used and the temperature already exceeds the desired value. Although an elevated temperature of the gas is desired to achieve the desired results, a temperature which exceeds the desired range, e.g., above 500 degrees Celsius, may cause coking in the combustion chamber 102, may cause combustion to take place too soon, and may cause excessive component wear.

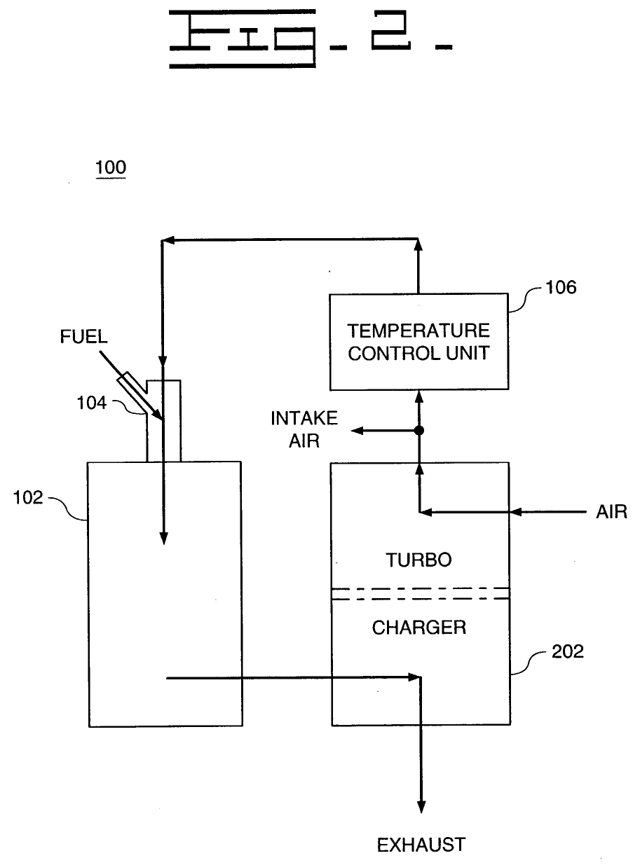

Referring to FIG. 2, a block diagram depicting an alternate embodiment of the present invention is shown.

The exhaust gas from the combustion chamber 102 passes through a turbo-charger 202. In addition, fresh air enters the turbo-charger 202. It is well known in the art that the exhaust gas passes through a turbine portion (not shown) of the turbo-charger 202, which drives a compressor portion (not shown), which in turn compresses the air entering the turbo-charger 202. The compressed air is then delivered to an engine as intake air, preferably through an intake manifold (not shown).

In the embodiment of FIG. 2, however, a portion of the compressed air is delivered to the fuel injector 104, for use in gas assisted injection of the fuel. The compressed air may, however, first pass through a temperature control unit 106 to achieve a desired temperature of the air. Although the turbo-charger 202 may heat the air somewhat during the compression process, it may be desired to heat the air an additional amount. Alternatively, it may be desired to cool the air an amount to achieve the desired temperature prior to entering the fuel injector 104.

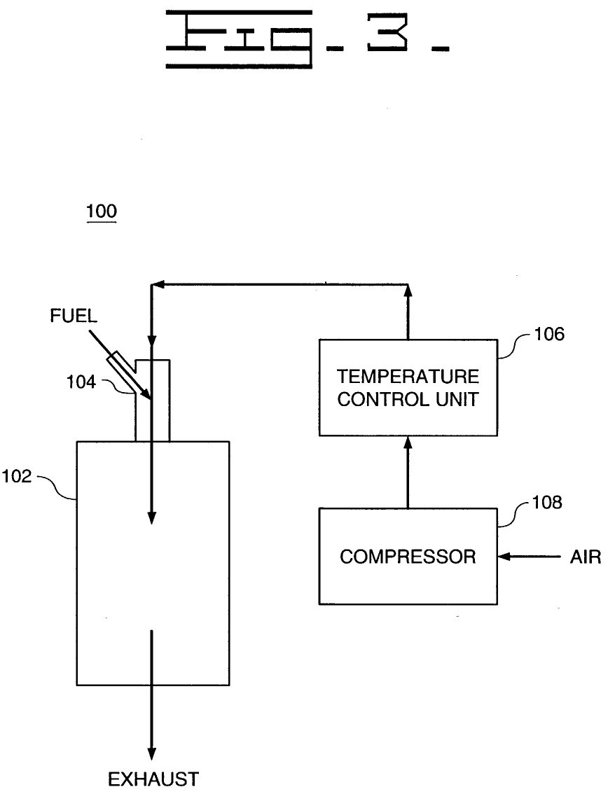

Referring to FIG. 3, a block diagram illustrating another alternate embodiment of the present invention is shown.

A source of fresh air is delivered to a compressor 108. The compressor 108 may be an isolated air compressor used primarily for purposes of the present invention, or may be a compressor used for some other purpose as well, such as an air brake compressor on a large truck.

The compressed air is delivered to the fuel injector 104 for gas assist purposes as described above. Preferably, the compressed air is delivered through a temperature control unit 106 to either heat or cool the air to the desired temperature.

### INDUSTRIAL APPLICABILITY

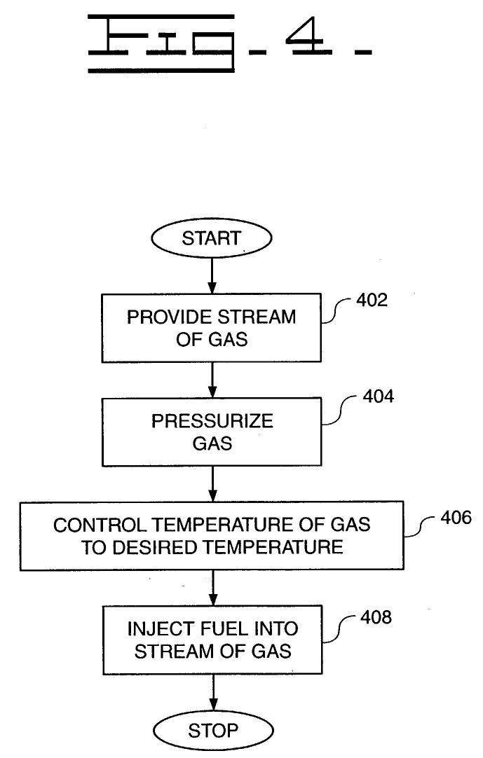

Operation of the present invention may best be described with reference to the flow diagram of FIG. 4, which depicts a preferred method of the present invention.

In a first control block 402, a stream of gas is provided. The stream of gas may be air, EGR gas or some other suitable source of gas for use in a gas assist injector.

In a second control block 404, the stream of gas is pressurized, for example by one of the compressor methods described above.

In a third control block, the temperature of the gas is controlled to within a desired temperature range, for example from about 300 degrees Celsius to about 500 degrees Celsius. It is noted that, although compression of the gas is described as taking place prior to temperature control of the gas, it may be desired to achieve temperature control prior to compression without deviating from the scope of the invention.

In a fourth control block 408, fuel is injected into the stream of gas as the gas passes through the fuel injector 104. Preferably, the chosen temperature of the gas results in atomization of the fuel into droplets having a size of about 10 microns and less. Without temperature control of the gas, typical fuel droplet size would range from about 30 to about 100 microns.

Other aspects can be obtained from a study of the drawings, the disclosure, and the appended claims.

What is claimed is:

1. A method for atomizing fuel being delivered for combustion, including the steps of:
providing a stream of pressurized gas;
controlling a temperature of the stream of gas to a desired temperature; and
injecting a quantity of fuel into the stream of gas;
wherein the desired temperature is selected to atomize the fuel to a desired fuel droplet size.

2. A method, as set forth in claim 1, wherein providing a stream of pressurized gas includes the step of providing a stream of pressurized air.

3. A method, as set forth in claim 1, wherein providing a stream of pressurized gas includes the step of providing a stream of pressurized exhaust gas recirculation (EGR) gas.

4. A method, as set forth in claim 1, wherein providing a stream of pressurized gas includes the step of providing a stream of at least one of pressurized air and pressurized exhaust gas recirculation (EGR) gas.

5. A method, as set forth in claim 1, wherein controlling a temperature of the stream of gas includes the step of controlling a temperature of the stream of gas to a temperature within a range from about 100 degrees Celsius to about 500 degrees Celsius.

6. A method, as set forth in claim 1, wherein controlling a temperature of the stream of gas includes the step of controlling a temperature of the stream of gas to a temperature within a range from about 300 degrees Celsius to about 500 degrees Celsius.

7. A method, as set forth in claim 1, wherein the desired temperature is selected to atomize the fuel to a desired fuel droplet size of about 10 microns.

8. A method, as set forth in claim 1, wherein the desired temperature is selected to atomize the fuel to a desired fuel droplet size of less than 10 microns.

9. A method, as set forth in claim 1, wherein injecting a quantity of fuel includes the step of injecting a quantity of liquid fuel into the stream of gas.

10. A method for providing atomized fuel to a combustion chamber, including the steps of:
providing a stream of gas;
pressurizing the gas to a desired pressure;
controlling a temperature of the stream of gas to a desired temperature; and
injecting a quantity of fuel into the stream of gas;
wherein the desired pressure and the desired temperature are selected to provide atomized fuel at less than a specified fuel droplet size.

11. An apparatus for atomizing fuel being delivered for combustion, comprising:
a source of gas being delivered in a stream;
a compressor located such that the stream of gas passes therethrough and is pressurized;
a temperature control unit located such that the stream of gas passes therethrough and is controlled to a desired temperature;
a fuel injector for injecting fuel into the stream of gas after the gas passes through the compressor and the temperature control unit, wherein the fuel is atomized to a desired fuel droplet size as a function of the desired temperature; and
a combustion chamber for receiving the atomized fuel for combustion.

12. An apparatus, as set forth in claim 11, wherein the source of gas is at least one of air and exhaust gas recirculation (EGR) gas.

13. An apparatus, as set forth in claim 11, wherein the desired temperature is within a range from about 100 to 500 degrees Celsius.

14. An apparatus, as set forth in claim 11, wherein the desired temperature is within a range from about 300 to 500 degrees Celsius.

15. An apparatus, as set forth in claim 11, wherein the desired fuel droplet size is about 10 microns.

16. An apparatus, as set forth in claim 11, wherein the desired fuel droplet size is less than 10 microns.
